(19) United States
(12) Patent Application Publication
(10) Pub. No.: US 2016/0364253 A1
(43) Pub. Date: Dec. 15, 2016

(54) METHOD FOR DYNAMIC MULTIMEDIA PLAYBACK PROCESSING

(71) Applicant: Daniel William Moffatt, Edina, MN (US)

(72) Inventor: Daniel William Moffatt, Edina, MN (US)

(21) Appl. No.: 15/176,093

(22) Filed: Jun. 7, 2016

Related U.S. Application Data
(60) Provisional application No. 62/173,292, filed on Jun. 9, 2015.

(51) Int. Cl. G06F 9/445; G11B 27/10

(52) U.S. Cl. CPC G06F 9/44505; G11B 27/10

(57) ABSTRACT

The present invention is a method and system for dynamic playback of multimedia content. More specifically, the present invention includes an playback configuration file that contains instructions for playback. Hence, the instructions contained within a playback configuration file may result in varying output with each successive playback. This change in each playback is due to condition changes in the underlying operating system and services, user actions, available networked devices or musical instruments, conditions and instructions from remote web services, local services, calendar or other factors as defined in the playback configuration file. Further, the present invention integrates with other networked peripheral devices or musical instruments, networked lighting and telecommunication systems to extend the playback experience.

### CROSS-REFERENCE TO RELATED APPLICATION(S)

This application claims the benefit of U.S. Provisional Application No. 62/173,292 filed Jun. 9, 2015, the contents all of which are incorporated by reference.

### TECHNICAL FIELD

This invention relates to the field of computer file processing. More specifically, the method herein describes the processing, synchronization and playback of multiple multimedia files and networked resources as a result of and with respect to playback definitions, parameters and instructions configured in a computer file format providing specific file playback handling. This invention enables the multimedia playback process described herein to produce output that is mutable and dynamic.

### BACKGROUND OF THE INVENTION

Since the invention of recorded media, the output of audio and visual content has been static. The playback of records, tapes, film, video, CDs and others formats do not change from playback to playback. Further, the production process is such that the finished product is produced and mastered specifically for playback systems that do not support any dynamic change over time. As such, music, film or other audio/visual content playback remains constant in perpetuity.

For example, in the early years of audio recording, one or more microphones would be placed to record musical instruments. The sound information would then be converted and stored and ultimately pressed onto vinyl for distribution. The playback of the vinyl record assumes the playback equipment meets certain minimum requirements to render the audio correctly. Neither the vinyl disc nor the playback equipment is designed to change or alter in anyway the playback of the sound. Other than a malfunction, the playback of the record will render the same playback on each use.

Today, digital content playback is similar to vinyl and acetate in many ways. While digital based recording and production holds many editing and signal processing benefits, the final output again remains static. For example, CD and DVD content are produced assuming playback systems that render output consistently. Essentially, only the means in which the source is converted, stored and represented for playback has changed. As in the early years of records and film, the result to the listener and/or viewer remains unchanged. In all cases, the selected audio or video will render exactly the same way each time the content is to be played on the playback device.

Furthermore, there are various computer file formats that represent images, audio and visual data for display/playback on conventional media devices or software applications. Standard audio, visual codec as well as industry standard computer image formats are output by devices and processes that support the respective file formats. These output devices conform to the standard decoding conventions of the respective file formats to provide output. Standard decoding devices create static output. Upon each successive play or rendering of a file, the decoding and output does not change. Further, these decoding processes do not employ intelligence, advanced conditional processing or utilize advance features of computing devices.

This invention however, re-defines the common playback assumptions and methods of the past. Rather than referencing an unchanging, static file or disc as the source of information for playback, this playback process requires a mutable, configurable file format that can effectuate alternate playback output. The result of which is multimedia content that can be forever changing, evolving as well as configured for personal and unique use. Dynamic playback is output that may changes with each successive decoding. This invention achieves dynamic playback through the use of a supporting file format as well as processing logic that creates unique playback at runtime.

Furthermore, this playback process supports multiple audio, video and other sources that may be mixed and processed for playback according to instructions in the underlying playback configuration file. The playback specification in the playback configuration file determines when and how the individual resources are included in the playback output.

The playback processing features enable creative musicians and those in the visual arts to collaborate to create dynamic content. It provides an output platform to render these works and address the deficiencies of current playback technology.

Consequently, there is a need in the art for a dynamic multimedia playback processing method to enable artists to create and distribute audio and visual content that is mutable and ever changing. Further, this processing method supports, encourages and enhances collaboration between artists of variable abilities to share, contribute and distribute mutable audio and video content.

### BRIEF SUMMARY OF THE INVENTION

The present disclosure, in one embodiment, relates to processing a specialized file format containing a specification and instructions for the proper playback output by the multimedia playback processor. This specialized configuration file, referred to as the playback configuration file, may contain embedded standard multimedia file formats, references and/or instructions to locate and obtain standard multimedia file formats, signal/file processing instructions, rendering instructions, rendering and playback conditions, references to or embedded other playback configuration files, artist information and artist defined metadata.

The present disclosure, in one embodiment, relates to a four step process that includes parsing the playback configuration file, preparing the multimedia files and resources, executing real-time playback instructions and sending the resultant output to the underlying operating system for audio and video output.

The present disclosure, in one embodiment contains real-time playback instructions that determine the disposition, sub-processing and execution of resources during playback. The available instructions are limited only by the capabilities of the underlying operation system, the available playback services of the operating system and other resources and/or peripherals available on the network. Multimedia playback processing on a mobile device that includes an accelerometer, GPS service, touch sensitive display or other advanced features allow for playback instruction mappings for such events during playback by the multimedia playback processor. For example, the playback processor is operating on a mobile device which recognizes orientation changes. The playback configuration file contains an event that specifies to play the drum track backwards when the device is turned upside down.

In another embodiment of the present disclosure, real-time playback may include synchronized playback with networked musical instruments or other networked multimedia resources. For example, a player piano discovered on a wifi network may play a piano track synchronized with the other multimedia tracks included in the playback as specified in the playback configuration file.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed descriptions are to be regarded as illustrative in nature and not restrictive.

### BRIEF DESCRIPTION OF THE DRAWINGS

FIG. 1 illustrates the process of parsing the playback configuration file in one embodiment of the invention.

FIG. 2 illustrates the composition initialization (playback preparation process) for multimedia files, resources, playback instructions and artist information retrieval in one embodiment of the invention.

FIG. 3 illustrates the playback event manager in one embodiment of the invention.

FIG. 4 illustrates the real-time multimedia playback processor in one embodiment of the invention.

### DETAILED DESCRIPTION OF THE PREFERRED EMBODIMENT

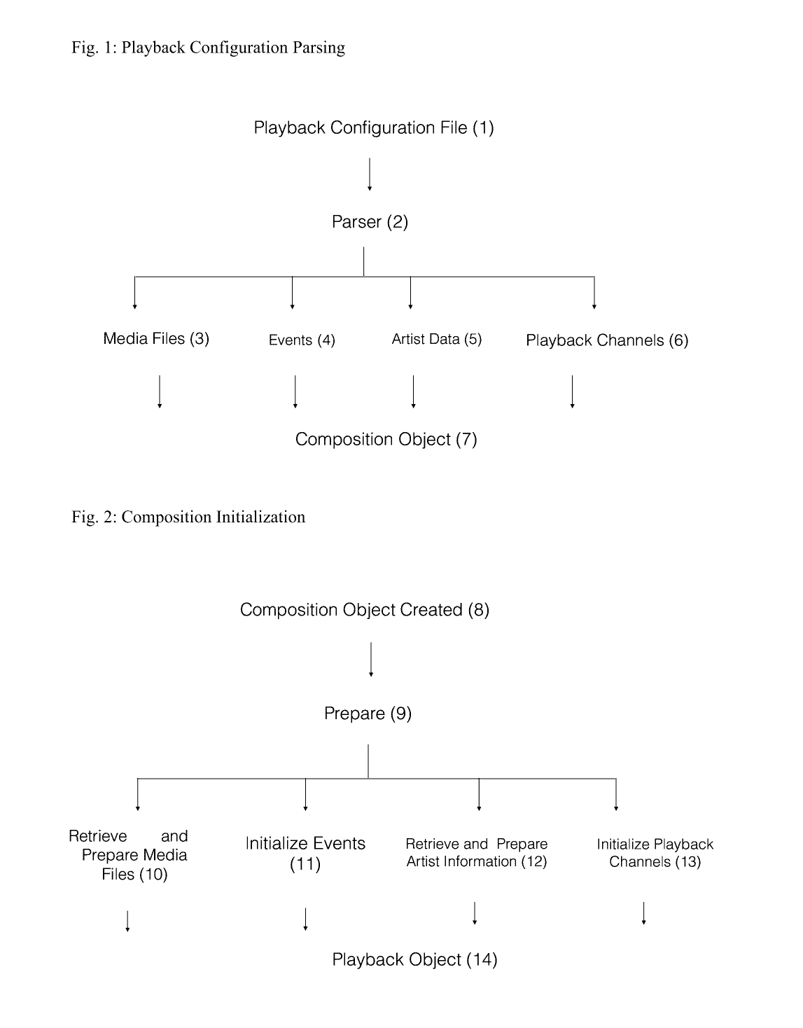

FIG. 1 shows a playback configuration file (1) that is received by a parsing routine (2). The parsing routine (2) extracts instruction and configuration playback specifications relating to media files (3), events (4), artist data (5) and the playback channels (6) necessary for proper playback of the multimedia content. Extracted data is prepared and converted as necessary, aggregated and stored in the composition object (7). In an alternate embodiment of the present invention, the aggregated parsed data may be organized into more than one class or structure to represent the parsed data.

FIG. 2 shows a created composition object (8) processed by the prepare (9) processor. The prepare processor (9) manages and procures the resources required for proper playback. In one embodiment of the present invention, the prepare processor (9) requests the retrieval of the defined multimedia files (10) identified in the composition object (8). The specified multimedia files may be retrieved from a web service, database, embedded in the playback configuration file (1) and stored locally, or other service provider. The prepare processor (9) then initializes the supported events (11). The event initialization prepares the proper notifications and handlers to realize operating system or playback events. The prepare processor (9) further retrieves artist information (12) defined in the composition object (8) from either web services, embedded data in the playback configuration file (1), local database or other provider and caches the data received. The prepare processor (9) initializes the defined playback channels (13) from the composition object (8). A playback channel may be audio, video, both audio and video, document file, image or another playback configuration file (1).

FIG. 3 illustrates the playback initialization, creation of the event manager and playback processor and the event manager reference to operating system services. The created playback object (15) prepares and creates (16) the event manager (17) and the playback processor (18). The event manager (17) notifies the playback processor (18) of events that occur from notifications from operating system events from various operating system services (19,20,21,22,23,24). When an operating system event occurs, the event manager (17) is notified. The event manager (17) searches a list of event for a match. If found, the event manager (17) notifies the playback processor (18) of the occurrence and performs any specified action.

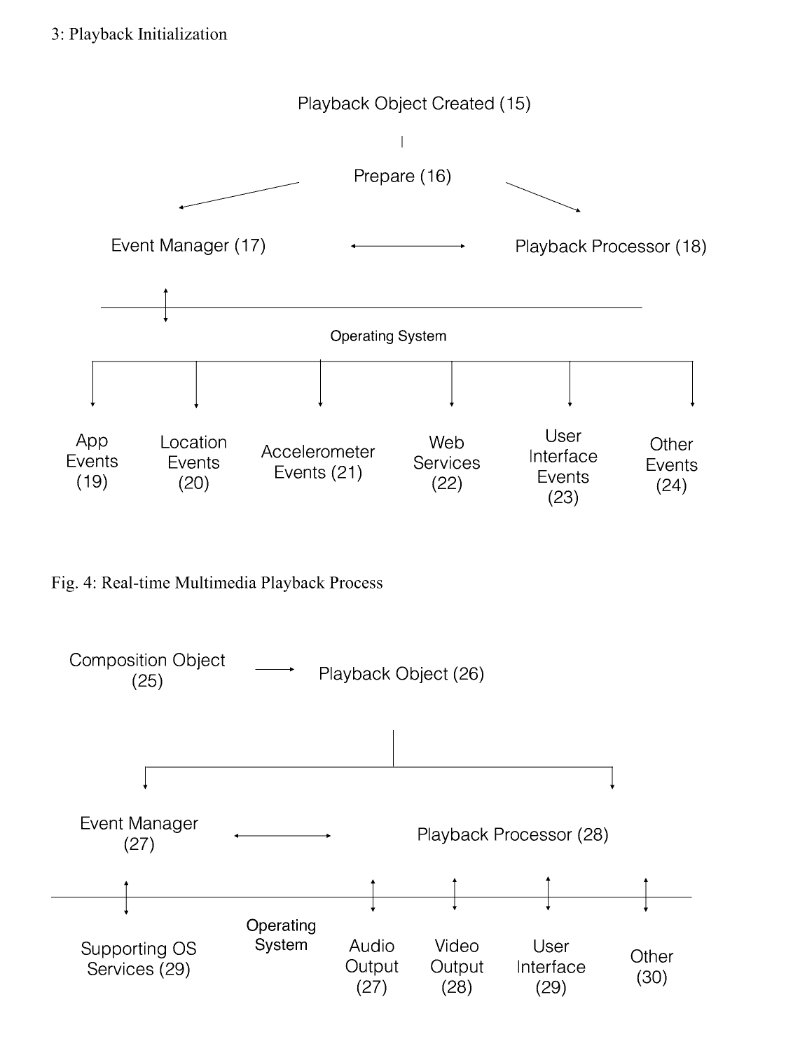

FIG. 4 illustrates the real-time multimedia playback process. In one embodiment of the invention, the created composition object (25) is passed to the playback object (26). The playback object (26) creates an event manager (27) and playback processor (28). The event manger (27) creates a list of mapped events that modify the playback defined in the composition object (25). The playback processor prepares and buffers the multimedia files for the channels referenced in the composition object (25). When the playback begins, the playback process (28) notifies the event manager (27) to begin event monitoring. As events occur in the supporting OS services (29) the event manager (27) notifies the playback processor (28) passing the mapped playback instructions for the event. During playback the playback processor notifies the event manager (17) of playback status and the completion status of event tasks received from the event manager (17).

For example, in one embodiment of this invention, the playback configuration file (1) is received from a web service through network communications on a mobile phone. The mobile phone is running an application hosting the components of this system. The data inside the playback configuration file (1) contains information that represents a song having six playback channels; drums, bass, piano, guitar, voice and video. The audio file for the drum channel is obtain by making a remote web service call which returns a single audio file. This audio file returned may be different each time the file is requested as the web service may select a different audio file determined by the user profile, the user's location, time, a random algorithm or any other means. The bass channel is represented by an embedded midi (musical interface digital interface) file. The piano channel is represented by two embedded files; one is an audio file and the other proprietary file format for a networked player piano. In this embodiment, the proprietary player piano file takes preference in the playback processor (28) should a compatible, networked player piano be recognized during the preparation (9) of the playback. For example, should the user travel away from the home where no networked player piano is available, the default piano audio will play. However, should the user return home where a networked player piano exists, the player piano will play the piano part. Further, and in a similar way, should a midi peripheral device be identified on the network, the bass midi file will be directed to this peripheral for playback. A web service is called for the guitar channel and it returns a single audio file. The voice channel is represented by an embedded audio file. The file (1) also includes four events; 180 degree rotation event, a “shake” gesture event, a GPS location position event which specifies a 100 mile radius of Chicago, Ill. and a teleconference event. All of these events, except the teleconference event are mapped to multimedia files and require the preparation (9) to fetch the referenced files for playback. The 180 degree rotation event is mapped to the voice channel and instructs the playback processor (28) to play an alternative voice audio file when the device rotation is recognized. This enables the user to rotate the phone and switch between two different voice performances. The shake gesture is mapped to the song's video file. When this gesture is recognized, the event manager (27) instructs the playback processor (28) to notify the operating system to play the mapped video file. The location event specifying a position within 100 mile radius of Chicago, Ill. is mapped to instructions to play a separate guitar audio file should the mobile phone be within the 100 mile radius. Once the phone enters this range, the event manager (27) instructs the playback processor (28) to play this alternate audio file instead of the default guitar audio file referenced with the channel. The teleconference event activation is specified with a small activation time window. Should playback take place within the time window and the mobile device supports teleconferencing, a teleconference session will commence between the user and the artist at the start of the playback processor. In this embodiment of the invention, the playback configuration file (1) also contains artist data including biographies of the musicians, images, and links to personal websites. During playback, the playback processor (28) makes this data available to the user interface (29) as directed by the event manager (27).

1. A system for dynamic multimedia playback processing comprising:
a microprocessor comprising:
an operating system, memory, network communication access and disk storage;
an application containing:
a playback configuration file;
a playback configuration parser;
a composition object comprising:
a prepare routine;
a playback object comprising:
an event manager and a playback processor.

2. The playback configuration file of claim 1 further comprising:
a unique, universal identifier,
a title,
one or more images,
a list of authors,
a contribution type or description for each said author,
a list of parts,
one or more tracks for each said part,
one or more segments for each said track,
a list of contributors for each said track,
one or more events for each said part,
one or more events for each said track,
one or more events for each said segment.

3. The parts of claim 2 wherein each part specifies a single component to said playback processor and includes an unique identifier, specifies a date and time that determines when the part is active to the said playback processor, a date and time when the part expires to the said playback processor and one or more said events that instructs the said playback processor via the said event manager.

4. The events of claim 3 wherein each event determines the processing for all related said tracks to the said playback processor via the said event manager.

5. The event of claim 4 wherein the said event may be realized as a result of a condition or change in the underlying operating system, any condition or change in any available operating system service, any condition or change due to user interaction, any time and/or calendar related condition, any geographic condition, any movement encountered by the operating system, any instructions received from a remote service using any communication means including conventional networks, bluetooth, zigbee or other network, any condition or change encountered with a connected peripheral device, any condition or change derived from a networked musical instrument, other networked peripheral device or a change of condition or state of the playback processor via the said event manager.

6. The tracks of claim 2 wherein each track specifies a date and time that determines when the track is active to the said playback processor, a date and time when the track expires to the said playback processor, one or more events that instruct the said playback processor via the said event manager and one or more segments.

7. The events of claim 5 wherein each event determines the processing for all related said segments to the said playback processor via the said event manager.

8. The event of claim 7 wherein each said event may be realized as described in claim 5.

9. The segments of claim 5 wherein each segment may specify the playback of audio, video, one or more images, one or more documents, one or more networked musical instruments, one or more networked video display systems, one or more networked lighting systems, text to voice, conduct a video conference, conduct a voice conference or reference and redirect a different said playback configuration file to the said playback processor; and wherein each segment includes a date and time that determines when the segment is active to the said playback object, a date and time when the segment expires to the said playback object, one or more events that instruct the said playback object.

10. The event of claim 10 wherein each event may be realized as described in claim 5.

11. The playback configuration parser of claim 1 further comprising:
a means to retrieve or obtain said playback configuration file;
a routine and method to extract elements of said playback configuration file as disclosed in claim 2;
a means to store the results of the extracted elements.

12. The composition object of claim 1 further comprising:
a means to contain the results of said playback configuration parser;
a routine to retrieve, prepare and contain media files;
a routine to retrieve, prepare and contain data for networked musical instrument playback;
a routine to retrieve, prepare and contain data for networked peripheral devices;
a routine to retrieve, prepare and contain author and artist information;
a routine to organize prepared data for the said playback object.

13. The playback object of claim 1 creates one said event manager and one said playback processor.

14. The event manager of claim 1 wherein it monitors changes and probes for conditions in the underlying operating system, the operating system services, peripheral devices, networked musical instruments, remote services, user actions, time, calendar or playback processor changes as determined by the list of events for parts, tracks and segments; and wherein the said event manager notifies the said playback processor of all occurrences of realized events.

15. The playback processor of claim 1 wherein is responsible to execute the playback of one or more audio files, execute the playback of one or more video files, request the display of one or more documents, request the display of one or more images, send data and/or commands to networked musical instruments, send data and/or commands to networked peripherals, send data and/or command to networked lighting systems, execute text to voice, execute a video conference, execute a voice conference or execute a separate said playback configuration file; and
wherein the playback processor is responsible to execute event instructions specified in event notifications sent from the event manager; and
wherein the playback processor notifies the event manager of state changes and completion results from event executions.

16. The event instructions from claim 15 wherein playback processing instructions are communicated to the said playback processor.

17. A method to create dynamic multimedia output as a result of:
parsing a playback configuration file;
creating a composition object;
preparing the composition object;
creating the playback object;
creating the event manager;
preparing the event manager;
creating the playback processor;
preparing the playback processor;
starting the event manager;
starting the playback processor;
event manager receiving notifications;
event manager notifying the playback processor;
playback processor directing multimedia output;
playback processor directing user interface output;
playback processor directing networked musical instrument output;
playback processor directing lighting output;
playback processor directing peripheral device output;
playback processor directing text to voice output;
playback processor directing video conferencing;
playback processor directing teleconferencing;
playback processor sending state information to event manager.

18. The dynamic multimedia output from claim 17 wherein the said dynamic multimedia output may be one or all of the following:
audio,
video,
image display,
text or document on a video display,
networked lighting control,
networked musical instruments,
control of other peripheral devices,
text to voice,
video conferencing,
teleconferencing.

19. The parsing a playback configuration file from claim 17 wherein the following data is extracted:
title,
images,
a list of authors,
a contribution type or description for each said author,
a list of parts,
one or more tracks for each said part,
one or more segments for each said track,
a list of contributors for each said track,
one or more events for each said part,
one or more events for each said track,
one or more events for each said segment.

20. The creating a composition object from claim 17 wherein said data from claim 18 is received in the initialization of said composition object.

21. The preparing the composition object in claim 17 wherein said data from claim 18 is prepared by:
retrieving media files from remote web services;
retrieving media files from local or remote network drives;
retrieving media files from peripheral devices;
extracting media files embedded in said playback configuration file;
retrieving specified resources as defined in said events;
retrieve specified resources as defined for said artist information;
organizing said parts, said tracks and said segments into playback channels;
whereby the number of said playback channels are inferred from the number of said parts.

22. The creating the playback object in claim 17 wherein the said playback object is initialized with the said composition object.

23. The creating the event manager in claim 17 wherein the said event manager receives a list of events.

24. The preparing the event manager in claim 17 wherein the said event manager creates an active event list from said events defined in the said playback configuration file. The said active event list instructs the said event manager to monitor changes and/or conditions of:
underlying operating system,
underlying operating system services,
user interaction,
time and/or calendar status,
geographic status,
device movement,
peripheral device status or instructions,
networked musical instruments status,
remote services status,
playback processor status.

25. The event list in claim 23 wherein the said event manager subscribes to receive notification and/or creates polling routines to recognize event activation.

26. The creating the playback processor in claim 17 wherein is initialized with the said playback object.

27. The preparing the playback processor in claim 17 wherein audio, video buffers are prepared and created and the said event manager is notified of said playback processor in ready state.

28. The starting the event manager in claim 17 wherein the said event manager receives the said ready state noted in claim 27 from the said playback processor which signals said event manager to begin monitoring and polling for said events listed in the said active event list in claim 24.

28. The starting the playback processor in claim 17 wherein the said event manager notifies the said playback processor when to begin playback processing.

29. The playback processing in claim 28 wherein said playback processing includes:
audio output,
video output,
commands to display of images on a video display,
commands to display of text or document on a video display,
commands to control networked lighting,
commands and communication with networked musical instruments,
control of other peripheral devices,
commands and control of text to voice output,
command and control of video conferencing,
common and control of teleconferencing.

30. The event manager receiving notifications in claim 17 wherein the said event manager monitors changes and conditions in resources as noted in claim 24.

31. The event manager notifying the playback processor in claim 17 wherein upon a match is encountered between a said event listed in said active event list with a change or condition in a monitored said resource, the said event manager notifies the said playback processor of occurrence and passes the said event instructions to the said playback processor.

32. The playback processor directing multimedia output in claim 17 wherein the said playback processor interfaces with the underlying operating system to facilitate the output.

33. The playback processor directing user interface output in claim 17 wherein the said playback processor interfaces with the underlying operating system to facilitate the user interface modifications.

34. The playback processor directing networked musical instruments output in claim 17 wherein the said playback processor interfaces with networked musical instruments to facilitate music and sound output.

35. The playback processor directing lighting output in claim 17 wherein the said playback processor interfaces with networked lighting systems to facilitate lighting changes.

36. The playback processor directing peripheral output in claim 17 wherein the said playback processor interfaces with various peripheral devices to control to create various output defined by the peripheral device.

37. The playback processor directing text to voice output in claim 17 wherein the said playback processor interfaces with the underlying operating system or third party text to voice technology to facilitate the text to voice output.

38. The playback processor directing video conferencing in claim 17 wherein the said playback processor interfaces with the underlying operating system or third party technology to facilitate a video conference session.

39. The playback processor directing teleconferencing in claim 17 wherein the said playback processor interfaces with the underlying operating system or third party technology to facilitate a teleconference conference session.

40. The playback processor sending state information to event manager in claim 17 wherein the said playback processor notifies the said event manager of all state, conditions and errors encountered.
